(19) United States
(12) Patent Application Publication
(10) Pub. No.: US 2006/0166707 A1
(43) Pub. Date: Jul. 27, 2006

(54) Control apparatus for an end key and a portable terminal employing the same

(75) Inventor: Sung-Tae Kim, Gyeonggi-do (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Pantech Co., Ltd.

(21) Appl. No.: 11/341,268

(22) Filed: Jan. 26, 2006

(30) Foreign Application Priority Data
Jan. 27, 2005 (KR) 10-2005-0007480

(51) Int. Cl. H04B 1/38; H04M 1/00

(52) U.S. Cl. 455/572

(57) ABSTRACT

A control apparatus for an end key in a portable terminal employing a keypad that enables a cathode control and the portable terminal incorporating therein the apparatus are provided. The control apparatus comprises a main power supply switch connected to a power supply unit and having at least control port for supplying a power to the portable terminal by being turned on if the control port is grounded, and an end key including a ground terminal connected to the ground and a first terminal coupled with the control port of the main power supply switch, wherein the first terminal forms a short circuit with the ground terminal if the end key is pressed.

### FIELD OF THE INVENTION

The present invention relates to an end key used in a portable terminal; and more particularly, to a control apparatus for an end key using a keypad that enables a cathode control and a portable terminal employing the apparatus.

### DESCRIPTION OF RELATED ART

An end key adopted in such portable terminals as portable telephone, PDA (personal digital assistant), DMB (digital multimedia broadcasting) phone and the like is generally utilized to conduct a cancellation function of each menu provided by the potable terminals as well as a power on/off function. Such an end key also serves to perform a variety of functions such as communication end, e.g., call end function upon call completion.

FIG. 1 shows an implementation example of a conventional end key control apparatus.

Referring to FIG. 1, the end key control apparatus comprises an end key 101, a main switch on/off unit 103, a main power supply switch 102, an end key push-sensing switch 107, and a residual voltage-removing unit 108, arranged in a portable terminal. Hereinafter, an operation of the prior art end key control apparatus will be explained with reference to FIG. 1. In the following explanation, for instance, it is assumed that a logic low level would be 0 V, and a logic high level would be over 3 V. Further, it should be noted that the meaning that a transistor or switch is “turned on” or “switched” would identically be used where necessary.

Specifically, firstly, an operation of making a power-on of a portable terminal will be described below. When a user presses the end key 101, the main switch on/off unit 103 is switched and at the same time the main power supply switch 102 is turned on. The main power supply switch 102 is utilized as a switch for providing a power to all elements involved in the portable terminal, wherein if a voltage at its gate becomes down to logic low level (ground), its drain and source are in a conduction state and turned on. If the main power supply switch 102 is turned on, a power is supplied from the power supply unit 110 including a battery (not shown) to the portable terminal via a port 104. Once the portable terminal is in a power-on state, a voltage-hold signal of certain level is applied to the main switch on/off unit 103 via a port 105 so that the gate of the main power supply switch 102 maintains the logic low level. The main switch on/off unit 103 is comprised of a transistor wherein it is configured in such a way that if the transistor is turned on, the gate of the main power supply switch 102 is coupled with the ground.

Thereafter, in the state where the power was applied to the portable terminal, an operation of executing a cancellation function of various menus and a call end function by means of the end key 101 will be introduced below. Applied to the end key push-sensing switch 107 via a port 109 is a modified voltage of certain level so as to always maintain above a constant voltage. If the end key 101 is pushed by the user for the menu cancellation or call end, the power is supplied to the base of the end key push-sensing switch 107 for switching, which is sensed by a controller (not shown) through a port 106.

Finally, an operation of doing a power-off of the portable terminal will now be presented. Conventionally, the portable terminal becomes in a power-off state when the end key is pushed for a long time. Namely, when the end key is pressed over a preset time, the controller senses it and then interrupts the power thereto. If the user lengthily pushes the end key 101, the end key push-sensing switch 107 is switched. If the end key push-sensing switch 107 is switched over the preset time, the port 106 maintains the logic low level during the switching time of the end key push-sensing switch 107. And, the controller recognizes such state and then motivates the voltage-hold signal applied to the main switch on/off unit 103 via the port 105 to be down to the logic low level. If the voltage-hold signal becomes down to the logic low level, the main switch on/off unit 103 is turned off and then the main power supply switch 102 is turned off. Simultaneously, the controller applies a power cutoff enable signal to the residual voltage-removing unit 108 via a port 111. If the power cutoff enable signal is applied to the residual voltage removing unit 108, a transistor 112 included therein is turned on, thereby removing a residual voltage charged in a condenser connected to the collector of the transistor 112 by passing it through the ground.

As mentioned above, however, since the end key of the conventional portable terminal controls lots of functions using one key, a hardware circuitry to implement such end key control apparatus is rather complicated. Accordingly, due to this complex circuitry configuration, implementing the end key control apparatus entails a bulky volume of devices involved.

Moreover, the conventional end key control apparatus is provided with a plurality of transistors for control pins of the controller to recognize logic high or low level via the anode of the battery and a multiplicity of diodes to prevent a reverse current of voltage. And also, a wire needs to be installed for the supply of the power from the battery to the end key, which yields a power noise and affects peripheral circuits.

### SUMMARY OF THE INVENTION

It is, therefore, a primary object of the present invention to provide an apparatus to solve the problems of the prior art as indicated above.

Specifically, an object of the present invention is to provide an end key control apparatus with the same functions as those of the prior art apparatus using a simple circuitry structure and a portable terminal employing the same.

Another object of the invention is to offer an end key control apparatus that enables an efficient supply of power through the use of a simple circuitry structure and a portable terminal having the same.

Still another object of the invention is to provide an end key control apparatus that doesn't need a complex power supply line and also doesn't affect peripheral circuits and a portable terminal with such apparatus.

In accordance with one aspect of the present invention, there is provided a control apparatus for an end key in a portable terminal, the control apparatus comprising: a main power supply switch connected to a power supply unit and having at least control port for supplying a power to the portable terminal by being turned on if the control port is grounded; and an end key including a ground terminal connected to the ground and a first terminal coupled with the control port of the main power supply switch, wherein the first terminal forms a short circuit with the ground terminal if the end key is pressed.

In accordance with another aspect of the present invention, there is provided a control apparatus for an end key in a portable terminal, the control apparatus comprising: a controller including at least push-sensing port wherein a cancellation of a running menu is recognized if the push-sensing port is grounded; and an end key including a ground terminal connected to the ground and a push-sensing terminal coupled with the push-sensing port of the controller, wherein the push-sensing terminal forms a short circuit with the ground terminal if the end key is pressed.

In accordance with still another aspect of the present invention, there is provided a control apparatus for an end key in a portable terminal, the control apparatus comprising: a controller including a push-sensing port and a power-hold signal output port wherein a power-off state of the portable terminal is recognized if the push-sensing port is grounded over a preset time; and an end key including a ground terminal connected to the ground and a push-sensing terminal coupled with the push-sensing port of the controller, wherein the push-sensing terminal establishes a short circuit with the ground terminal if the end key is pushed.

In accordance with a further aspect of the present invention, there is provided a portable terminal comprising: an end key including a dome for pressing, a ground terminal connected to the ground, and a first and a second terminals that establish a short circuit with the ground terminal if the dome is pressed; a controller including a push-sensing port connected to the second terminal, wherein a cancellation of a running menu is recognized if the push-sensing port is grounded, and a power-off state of the portable terminal is recognized if the push-sensing port is grounded over a preset time, to thereby cut off the power-hold signal; a main power supply switch connected to a power supply unit and having a control port coupled with the ground terminal for supplying a power to the portable terminal by being turned on if the control port is grounded, and cutting off the supply of the power by being turned off if the power-hold signal is interrupted by the controller; and a main switch on/off unit for holding the turn-on state of the main power supply switch, after the main power supply switch is turned on and the power is supplied.

The other objectives and advantages of the invention will be understood by the following description and will also be appreciated by the embodiments of the invention more clearly. Further, the objectives and advantages of the invention will readily be seen that they can be realized by the means and its combination specified in the claims.

### BRIEF DESCRIPTION OF THE DRAWINGS

The above and other objects and features of the instant invention will become apparent from the following description of preferred embodiments taken in conjunction with the accompanying drawings, in which:

FIG. 1 shows an implementation example of a conventional end key control apparatus;

FIGS. 2A to 2C are views illustrating the structure of an end key for explaining the principle of the present invention;

FIG. 3 illustrates an exemplary circuitry diagram showing a schematic configuration of a portable terminal incorporating therein an end key control apparatus in accordance with a preferred embodiment of the invention; and

FIG. 4 presents an exemplary circuitry diagram illustrating an implementation example of an end key control apparatus in accordance with the invention.

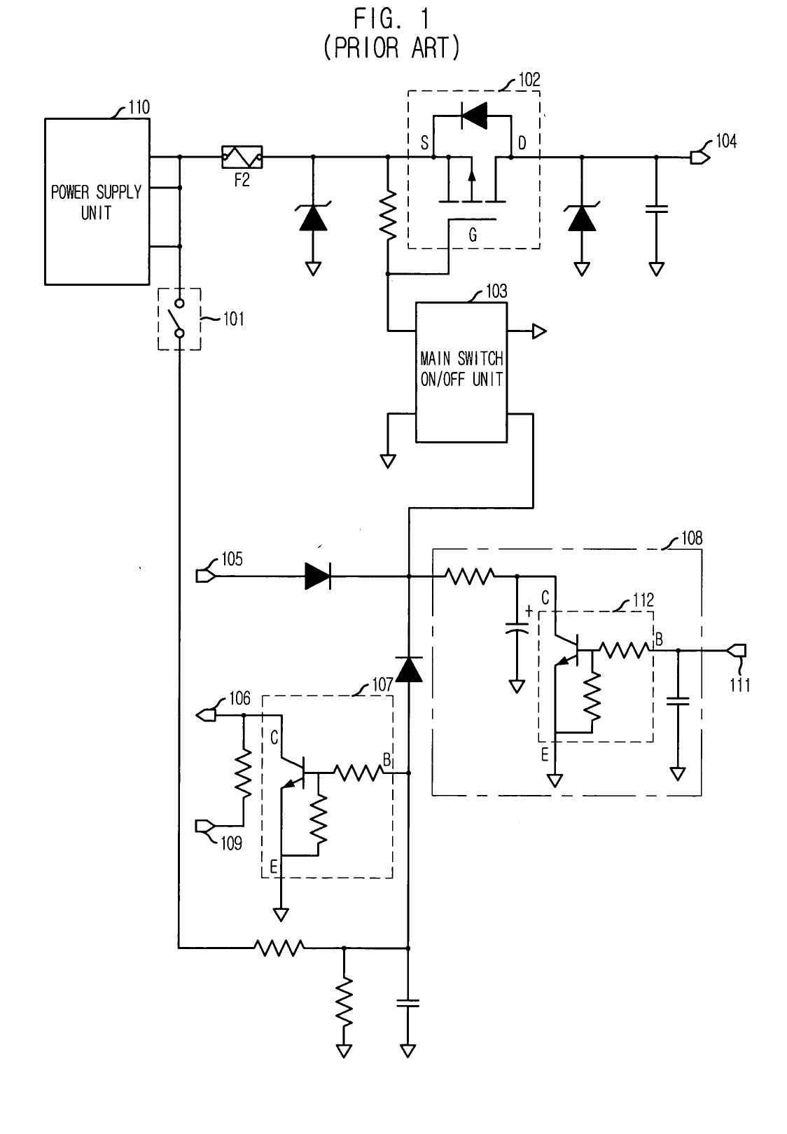

### DETAILED DESCRIPTION OF THE INVENTION

The above-mentioned objectives, features, and advantages will be more apparent by the following detailed description in association with the accompanying drawings; and the technical spirit of the invention will readily be conceived by those skilled in the art to which the invention belongs. Further, in the following description, well-known arts will be not described in detail if it seems that they could obscure the gist of the invention in unnecessary detail.

Hereinafter, a preferred embodiment of the present invention will be described in detail with reference to the accompanying drawings. Before introducing the preferred embodiment of the present invention, it should be noted that the terms and words adopted in the specification and claims should be interpreted as the meanings and concepts which coincide with the technical spirit of the present invention under the principle that the inventor(s) can properly define the concept of the terms to explain the invention in the best manner, without limiting to general or dictionary meanings.

In the following description, it should be noted that the term “port” is used as an input and output line and indicates each of parts physically coupled with other elements, which is adopted to distinguish from the term “terminal” mentioned in the following end key of the invention.

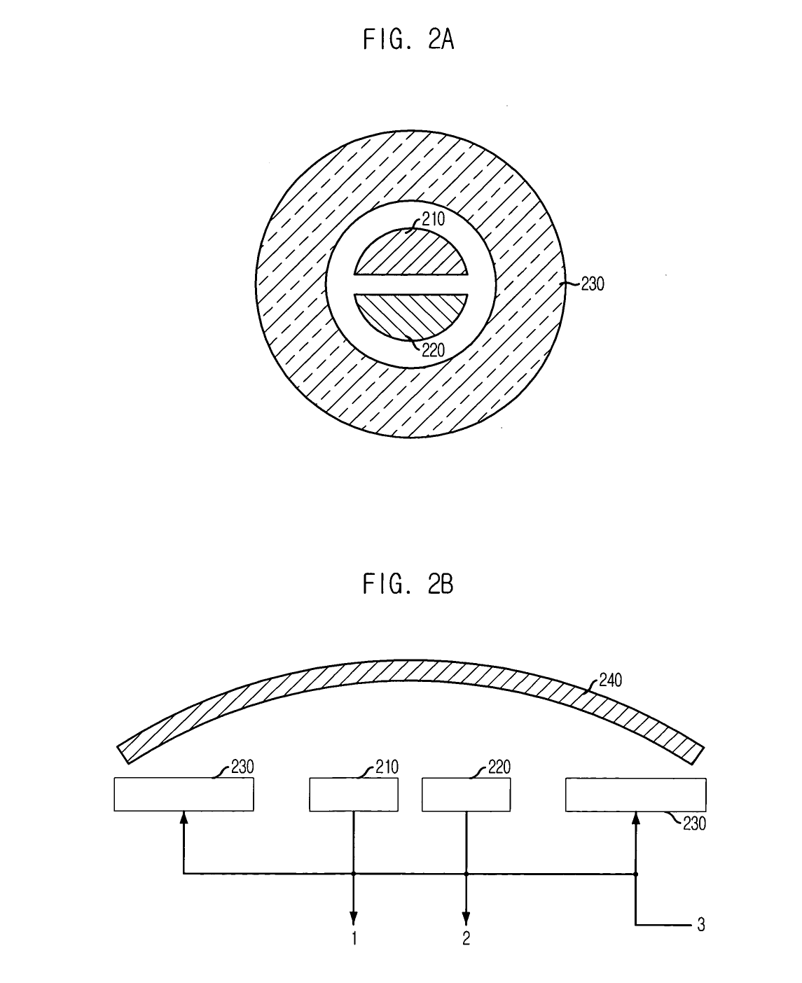

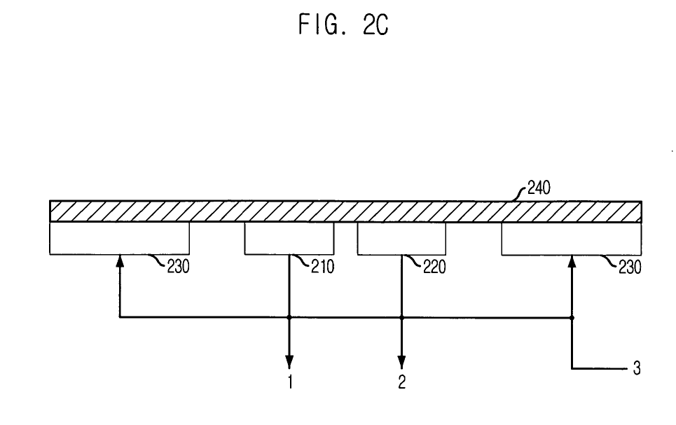

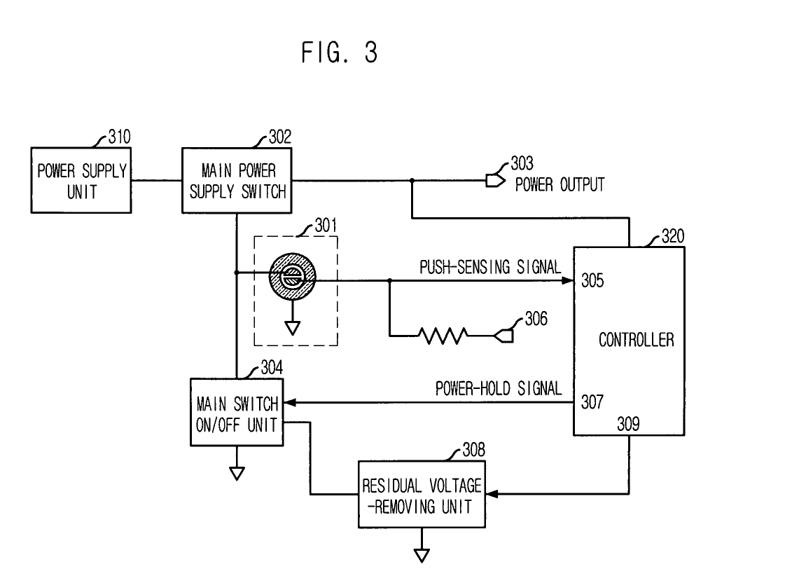

A fundamental principle of the present invention employs a keypad with three terminals of a new and unique shape depicted in FIGS. 2A and 2B as an end key. The keypad itself is grounded, thereby simplifying a structure of an end key control apparatus and also decreasing a power noise.

FIG. 2A is a view showing the shape of the three-terminal end key in accordance with the principle of the invention, and FIG. 2B is a view illustrating a connection structure of the three-terminal end key in accordance with the invention.

Specifically, referring to FIGS. 2A and 2B, the inventive end key comprises a dome 240 for pressing, and three terminals 210 to 230 for providing signal paths. Of course, the three terminals 210 to 230 may be implemented in various shapes.

In FIG. 2B, each of the three terminals is connected to three ports, 1 to 3, respectively. If the dome 240 is pressed, the three terminals 210 to 230 are in a short state, as depicted in FIG. 2C. Hence, in a state where the port 3 is grounded, if the dome 240 is pressed, the terminals 210 and 220 are also grounded. Of course, in case the port 3 is connected to logic high level, i.e., the anode of the battery, the result is opposite to the above state. In the following explanation, according to the function of each terminal, the three terminals will be described as terms as: the terminal 230 as “ground terminal”, the terminal 210 as “first terminal”, and the terminal 220 as “push-sensing terminal” or “second terminal”.

Hereinafter, details of the end key control apparatus using the three-terminal end key shown in FIGS. 2A to 2C will be described.

In the following description, it should be noted that the cancellation of each menu is used as the meanings including all of interruption of running game, end of phone number search, close of message preparation, etc, for the convenience of explanation. It should also be noted that the cancellation of each menu has the meanings inclusive of execution interruption of specific programs, and call end in mobile communication terminal where necessary.

FIG. 3 illustrates an exemplary diagram showing a schematic configuration of a portable terminal incorporating therein an end key control apparatus in accordance with a preferred embodiment of the invention.

Specifically, first of all, an operation of making a power-on of a portable terminal will be provided below referring to FIG. 3. When a user presses an end key 301, a main power supply switch 302 is turned on and in turn a power is supplied from a battery (not shown) prepared in a power supply unit 310 to the portable terminal via a power output port 303. The main power supply switch 302 may be implemented by MOSFET (metal oxide semiconductor field effect transistor), wherein, if its gate as control port is grounded, its drain and source become in a conduction state and are turned on.

In FIG. 3, connected to the end key 301 is a main switch on/off unit 304 that serves to maintain the turn-on state of the main power supply switch 302 after it is turned on and the power is supplied to the portable terminal. The main switch on/off unit 304 is a transistor that is turned on in response to a power-hold signal applied to its base wherein its collector is coupled with a control port of the main power supply switch 302 and its emitter is connected to the ground. Thus, in case the main switch on/off unit 304 was turned on, the gate as the control port of the main power supply switch 302 maintains the logic low level (ground).

And, coupled with both the end key 301 and the main switch on/off unit 304 is a controller 320 that controls to maintain the turn-on state by applying a voltage-hold signal of certain level to the main switch on/off unit 304.

Next, in the state where the power was applied to the portable terminal, an operation of performing a cancellation function of various menus and a call end function by means of the end key 301 will be explained below referring to FIG. 3. The controller 320 first recognizes a cancellation of a running menu if a push-sensing port 305 connected to the second terminal 220 is grounded. As disclosed above, the end key 301 in accordance with the invention is comprised of the ground terminal 230; and therefore, if the dome 240 is pressed, the push-sensing terminal 220 is configured to make a short circuit with the ground terminal 230, thereby causing the controller 320 to execute the cancellation operation of the running menu.

Finally, an operation of doing a power-off of the portable terminal will be given using the end key 301. The controller 320 first recognizes a power-off of the portable terminal if the push-sensing port 305 is grounded over a preset time (for example, 2 sec), and then breaks the power-hold signal. If the controller 320 breaks the power-hold signal, the main switch on/off unit 304 is turned off and at the same time the main power supply switch 302 is turned off, thereby rendering the supply of the power interrupted.

In FIG. 3, a residual voltage-removing unit 308 is substantially identical to the residual voltage removing unit 108 according to the prior art; and therefore, details thereof is omitted here for the sake of simplicity.

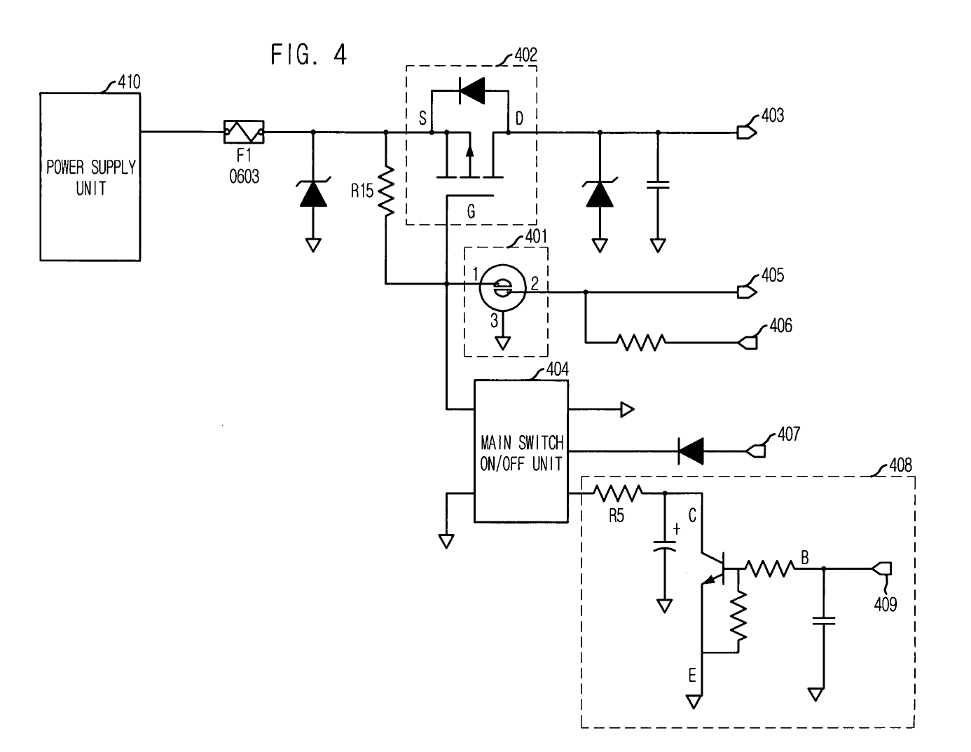

FIG. 4 presents an exemplary circuitry diagram showing an implementation example of the end key control apparatus in accordance with the invention.

It can be seen from FIG. 4 that the inventive end key control apparatus has a simple circuitry structure with no lines for the supply of the power, in comparison with the prior art end key control apparatus. Moreover, it can be seen that the invention doesn't need plural of diodes for preventing a reverse current of voltage.

As illustrated in FIG. 4, the end key control apparatus of the present invention comprises an end key 401 which includes the dome 240 for pressing, the ground terminal 230 connected to the ground, and the first and second terminals 210 and 220 which form a short circuit with the ground terminal 230 if the dome 240 is pressed, a main power supply switch 402 which is connected to the power supply unit 410 and the ground terminal 230 and includes a control port, and is turned on and supplies a power to the portable terminal if the control port is grounded, and a main switch on/off unit 404 for maintaining, after the main power supply switch 402 is turned on and the power is supplied, the turn-on state of the main power supply switch.

Included in the portable terminal is a controller (not shown) that has a push-sensing port 405 connected to the second terminal 220. If the push-sensing port 405 is grounded, the controller recognizes a cancellation of running menu; and if the push-sensing port 405 is grounded over a preset time, the controller recognizes the power-off of the portable terminal and intercepts the power-hold signal. If the power-hold signal is intercepted, the main power supply switch 402 is turned off, thereby halting the supply of the power to the portable terminal.

As set forth in the foregoing, the present invention can perform the same functions as those of the prior art and enable an efficient supply of power through the use of a simple circuitry configuration making a keypad itself grounded. Furthermore, the present invention removes complex lines for the supply of power, which doesn't affect the peripheral circuits.

The present application contains subject matter related to Korean patent application No. 2005-0007480, filed with the Korean Intellectual Property Office on Jan. 27, 2005, the entire contents of which are incorporated herein by reference.

While the present invention has been described with respect to the particular embodiments, it will be apparent to those skilled in the art that various changes and modifications may be made without departing from the spirit and scope of the invention as defined in the following claims.

What is claimed is:

1. A control apparatus for an end key in a portable terminal, the control apparatus comprising:
a main power supply switch connected to a power supply unit and having at least control port for supplying a power to the portable terminal by being turned on if the control port is grounded; and
an end key including a ground terminal connected to the ground and a first terminal coupled with the control port of the main power supply switch, wherein the first terminal forms a short circuit with the ground terminal if the end key is pressed.

2. The control apparatus as recited in claim 1, wherein the end key comprises:
a dome for pressing;
the ground terminal connected to the ground; and
the first and a second terminals that establish a short circuit with the ground terminal if the dome is pushed.

3. The control apparatus as recited in claim 1, further comprising a main switch on/off unit for holding the turn-on state of the main power supply switch, after the main power supply switch is turned on and the power is supplied.

4. The control apparatus as recited in claim 3, wherein the main switch on/off unit is a transistor that is turned on in response to a power-hold signal applied to the base.

5. The control apparatus as recited in claim 4, wherein the collector of the transistor is connected to the control port of the main power supply switch and the emitter is coupled with the ground.

6. A control apparatus for an end key in a portable terminal, the control apparatus comprising:
a controller including at least push-sensing port wherein a cancellation of a running menu is recognized if the push-sensing port is grounded; and
an end key including a ground terminal connected to the ground and a push-sensing terminal coupled with the push sensing port of the controller, wherein the push-sensing terminal forms a short circuit with the ground terminal if the end key is pressed.

7. The control apparatus as recited in claim 6, wherein the end key comprises:
a dome for pressing;
the ground terminal connected to the ground; and
the push-sensing terminal and a first terminal that form a short circuit with the ground terminal if the dome is pushed.

8. A control apparatus for an end key in a portable terminal, the control apparatus comprising:
a controller including a push-sensing port and a power-hold signal output port wherein a power-off state of the portable terminal is recognized if the push-sensing port is grounded over a preset time and a power-hold signal is interrupted; and
an end key including a ground terminal connected to the ground and a push-sensing terminal coupled with the push-sensing port of the controller, wherein the push-sensing terminal establishes a short circuit with the ground terminal if the end key is pushed.

9. The control apparatus as recited in claim 8, further comprising a main power supply switch that is turned off and cuts off the supply of the power if the power-hold signal is interrupted by the controller.

10. A portable terminal comprising:
an end key including a dome for pressing, a ground terminal connected to the ground, and a first and a second terminals that establish a short circuit with the ground terminal if the dome is pressed;
a controller including a push-sensing port connected to the second terminal, wherein a cancellation of a running menu is recognized if the push-sensing port is grounded, and a power-off state of the portable terminal is recognized if the push-sensing port is grounded over a preset time, to thereby cut off the power-hold signal;
a main power supply switch connected to a power supply unit and having a control port coupled with the ground terminal for supplying a power to the portable terminal by being turned on if the control port is grounded, and cutting off the supply of the power by being turned off if the power-hold signal is interrupted by the controller; and
a main switch on/off unit for holding the turn-on state of the main power supply switch, after the main power supply switch is turned on and the power is supplied.
